(19) United States
(12) Patent Application Publication
(10) Pub. No.: US 2014/0282118 A1
(43) Pub. Date: Sep. 18, 2014

(54) GRAPHICAL USER INTERFACE DISPLAYING MULTI-BRANCHED BROWSING HISTORY TREE FOR WEB NAVIGATION

(71) Applicant: Danny Naoshi Kumamoto, Garden Grove, CA (US)

(72) Inventor: Danny Naoshi Kumamoto, Garden Grove, CA (US)

(73) Assignee: KONICA MINOLTA LABORATORY U.S.A., INC., San Mateo, CA (US)

(21) Appl. No.: 13/834,235

(22) Filed: Mar. 15, 2013

(51) Int. Cl. G06F 3/0484

(52) U.S. Cl. CPC G06F 3/0484
USPC 715/760

(57) ABSTRACT

An improved web browser program and related web navigation method can store a browsing history having a tree structure with nodes on multiple branches. The browsing history tree is displayed in an area separate from, or partially overlapping, the area where the web page content is displayed. In the browsing history tree display, the nodes may be represented by thumbnails of the web pages, and the user can click a node to navigate to that page. In one embodiment, when a web page is a search result page meeting certain criteria and contains multiple search hit links, the web browser program automatically (without user initiation) accesses each search hit link to downloads its content (without actually displaying the page in the browser winder), and generates a thumbnail based on the downloaded content. The multiple thumbnails generated this way are added to the browsing history tree display.

### BACKGROUND OF THE INVENTION

1. Field of the Invention

This invention relates to an improved web browser and web navigation method, and in particular, it relates to a web browser having a graphical user interface (GUI) which displays a browsing history tree having multiple branches and which allows the user to navigate to any of the previously visited web pages in the browsing history tree.

2. Description of Related Art

Conventional web browsers, i.e. computer software applications that facilitate interaction between a user and the World Wide Web, typically maintain a browsing history of each browsing session, and provide browsing history tools (commands) to allow the user to go back to a web page that he previously visited. For example, the browsing history commands of a web browser may include “back” and “forward” commands which can be used to traverse back or forward to the immediately previous or subsequent web page that the user visited along a history chain. It may also provide a “go to” command that displays the history chain (or a part thereof) and allows the user to go to any one of the pages on the history chain. The browsing history commands may be implemented by back and forward arrow icons, menu items, keyboard key presses, etc.

### SUMMARY

The present invention is directed to an improved web browser and web navigation method and related graphical user interface display (GUI) that substantially obviates one or more of the problems due to limitations and disadvantages of the related art.

An object of the present invention is to make it easier for a user to view the history of a web browsing session where the previously visited pages have a relationship that forms a tree with multiple branches, and to more easily visit the previously visited pages on the browsing history tree.

Another object of the present invention is to make is easier for a user to navigate a page of web search result.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a computer for navigating the World Wide Web (web), which includes: displaying a web page in a first display area; and displaying a browsing history tree in a second display area, wherein the browsing history tree includes a plurality of nodes each corresponding to a web page that has been navigated to during a browsing session, and a plurality of lines each connecting two of the plurality of nodes to indicate a direction of navigation, wherein at least one of the plurality of nodes has three or more nodes connected to it.

In another aspect, the present invention provides a method implemented in a computer for navigating a collection of data, the collection of data comprising a plurality of data locations each having data content, the method including: displaying content of a data location in a first display area; and displaying a navigation history tree in a second display area, wherein the navigation history tree includes a plurality of nodes each corresponding to a data location that has been navigated to during a navigation session, and a plurality of lines each connecting two of the plurality of nodes to indicate a direction of navigation, wherein at least one of the plurality of nodes has three or more nodes connected to it.

In another aspect, the present invention provides a method implemented in a computer for browsing the World Wide Web (web), which includes: (a) receiving first data representing content of a first web page; (b) displaying the first web page in a first display area; (c) determining whether the first web page includes a plurality of web links each corresponding to a web search hit; (d) if the first web page is determined to include the plurality of web links each corresponding to a search hit, automatically obtaining second data representing contents for a plurality of second web pages respectively corresponding to the plurality of web links, and based on the second data, generating a plurality of thumbnail image respectively representing the plurality of second web pages; (e) displaying a browsing history tree in a second display area, the browsing history tree including a plurality of nodes and a plurality of lines each connecting two of the plurality of nodes, wherein the plurality of nodes includes a first node corresponding to the first web page and a plurality of second nodes respectively corresponding to the plurality of second web pages, and wherein the plurality of lines include a plurality of first lines each connecting the first node with one of the plurality of second nodes, wherein the plurality of second nodes are respectively represented by the plurality of thumbnail images.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above methods.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 schematically illustrate browsing history behavior of a prior art web browser.

FIG. 3 schematically illustrates a browsing history tree display according to a first embodiment of the present invention.

FIG. 4 schematically illustrates a browser window according to the first embodiment.

FIG. 4A schematically illustrates a browser window according to an alternative implementation of the first embodiment.

FIG. 5 schematically illustrates a web browsing method according to the first embodiment.

FIGS. 6A-6C schematically illustrates exemplary browsing history tree display windows according to various implementations of the first embodiment.

FIG. 7 schematically illustrates a browsing history tree display according to a second embodiment of the present invention.

FIG. 8 schematically illustrates a web browsing method according to the second embodiment.

FIG. 9 schematically illustrates a data processing apparatus in which embodiments of the present invention may be implemented.

### DETAILED DESCRIPTION OF PREFERRED EMBODIMENTS

This disclosure uses the term “web page” to generally refer to resources on the World Wide Web; such resources are not limited to any particular form. The web navigation method described here may also be used to navigate resources on other networks such as an intranet. Thus, the term “web page” should be understood broadly.

In a conventional web browser, a user may navigates from one web page to another by (1) entering a uniform resource identifier (URI) (including a uniform resources locator (URL)) into the browser (this includes selecting a bookmarked or “favorite” URL); (2) selecting (clicking, touching, etc.) a hyperlink in the currently displayed web page; (3) in the case of a web search or other search, entering a search query and being directed to a search result page in response thereto; (4) navigating to a previously visited web page using a browsing history command (e.g., “back”, “forward”, “go to” command); etc. In the first three cases, i.e. when the user navigates to a page by entering a URI, or selecting a link, or executing a search, the browser adds the navigated-to page as the next node in the browsing history. When the user navigates to a previously visited web page by using a browsing history command, the browser does not add the navigated-to page as a new node in the browsing history; rather, it merely moves the current position indicator along the browsing history chain to indicate the node that the user just navigated to.

It is noted that in some browsers, when the user navigates to a previously visited web page within the browsing history, the browse may display a cached page, i.e. a page stored on the user's computer locally when the user previously visited the web page, rather than re-loading that web page from the internet. The term “web page” can include such cached pages.

In a conventional web browser, the browsing history maintained for each browsing session is linear chain without branches. In other words, each node (a web page) in the history chain (for the current browsing session) has only one previous node, unless it is the first node, in which case it has no previous node, and only one subsequent node, unless it is the last node, in which case it has no subsequent node. The “back” and “forward” commands of the web browser will bring the browser to the immediately previous and subsequent node, respectively.

This type of linear browsing history has limitations and is inconvenient in many practical situations. One main limitation is that, if the user navigates to a node (X) located in the middle of the browsing history chain, and then navigates to a new web page, then the new page is added to the browsing history chain as the subsequent node of X and any previously existing nodes subsequent to node X are no longer a part of the browsing history chain. Even if some browser may actually store a list of all of the previously visited pages internally, it does not make the entire list available to the user for navigation purposes; rather, only the pages on the linear chain of history is made available to the users for navigation purposes. This is schematically illustrated by an example shown in FIG. 1.

As shown in FIG. 1, suppose the user navigated to web pages A, B, C, D, E, F, G, and H in that order. These pages are stored in the browsing history chain as a sequence of nodes, as schematically depicted in row (a) of FIG. 1, where the shaded node (H) indicates the current page displayed in the browser. Suppose the user then navigates back from page H to page D using the browsing history commands (“back” or “go to”), as depicted in row (b). At this time, nodes A through H are still displayed in the browsing history chain and the user can navigate to any of them. Suppose the user then navigates to page I from page D, and then to page J, as depicted in row (c), using means other than the browsing history commands. At this time, the displayed browsing history consist of nodes A, B, C, D, I and J. Nodes E, F, G and H, which were previously navigated to, are no longer a part of the browsing history display, and the user can no longer navigate to them using the browsing history commands. Likewise, suppose the user then navigates back to page B using the browsing history commands (row (d)), and then from page B to pages K, L and M (row (e)), then nodes C, D, I and J are no longer a part of the browsing history display.

This type of linear browsing history chain can be inconvenient in many situations. For example, in an example shown in FIG. 2, suppose web page B is a search result page and contains multiple search hits each being represented by a hyperlink on page B. The user selects a first search hit link, and explores a series of web pages C through H related to the first hit. The user then navigates back to the search result page B using the browsing history command, and selects a second search hit link, and explores a series of web pages K through M related to the second hit. As a result, the browsing history chain now contains the web pages navigated to that relate to the second search hit, while the pages previously navigated to that related to the first search hit are no longer a part of the browsing history chain. This makes it inconvenient if the user desires to go back and forth between a page related to the first search hit and a page related to the second search hit for comparison purpose. This result is schematically shown in FIG. 2, where the dashed rectangles and arrows depict the web pages that are no longer available as a part of the browsing history. The user cannot go back and forth between, for example, page E and page L using browsing history commands.

Although the user is able to create and preserve multiple browsing histories by opening new pages in new browser windows or tabs, the number of open windows or tabs would quickly become difficult to track and manage. Moreover, having multiple browser windows or tabs still does not give the user a clear visual picture of the relationship of the multiple web pages he visited.

Embodiments of the present invention improve conventional browser programs by storing all pages navigated to by the user, including branches, which form a browsing history tree. The browsing history tree is displayed to the user and can be used for navigation. The improved browser program provides the same or similar browsing history commands as in the conventional browser programs, including the “back”, “forward”, and “go to” commands, as will be described in more detail later. Unlike conventional browser programs which display a linear history chain, the improved browser program displays the history tree.

The browser program, browsing methods and related GUI displays described below can be implemented in a data processing system or apparatus (see FIG. 9) such as a computer 120 which includes a processor 121, an internal memory (e.g. RAM) 123 and a storage device (e.g. hard disk drive) 122. The data processing system carries out the method by the processor 121 executing computer programs stored in the storage device 122 read out to the RAM 123. The data may also be implemented in a circuit, including a fixed circuit or a programmable circuit, such as an FPGA (field programmable gate array) chip. The data processing apparatus is connected to a network such as the Internet. In one aspect, the invention is embodied in a data processing system or a circuit performing the described method. In another aspect, the invention is computer program product embodied in computer usable non-transitory medium having a computer readable program code embedded therein for controlling a data processing apparatus. In another aspect, the invention is a method carried out by a data processing system or circuit.

In the descriptions below, the embodiments are implemented as a part of an improved web browser program. Alternatively, the present invention may also be embodied in a stand-alone utility application that interacts with a web browser program.

A first embodiment of the present invention provides a web browser program, as well as related method, that stores a complete browsing history of a browsing session and displays the browsing history as a tree structure with multiple branches to facilitate navigation. FIG. 3 illustrates an example of the stored and displayed browsing history tree using the same browsing example as used in FIG. 1. In this example, the user navigated to web pages A through H in that order, then navigated back to page D using the browsing history commands, then navigated to pages I and J from page D, then back to page B using the browsing history commands, and then from page B to pages K, L and M. The browser stores all of the web pages A through M the user navigated to, along with the relative historic relationship among them (i.e. from which page to which page), and displays the browsing history in a tree representation as schematically shown in FIG. 3.

In the example shown in FIG. 3, the node B has two immediately subsequent nodes, C and K, and one immediately previous node, A; the node D has two immediately subsequent nodes, E and I, and one immediately previous node, C. Of course, the shape of the history tree depends on how the user browsed the web pages; sometimes, the tree may have only one branch.

In one implementation, the browsing history tree is displayed in a window 31 (the browsing history display window) which is separate window from the window in which the content of the web pages is displayed (the browser window 41, see FIG. 4). Those skilled in the art will appreciate that the two windows may be displayed on the desktop in an overlapping or non-overlapping manner, and each window may be active of inactive at a given time. The browsing history display window 31 may also be a popup window that exists temporarily. In an alternative implementation (see FIG. 4A), the browsing history tree display and the web page content display may be integrated in one window, in two separate areas of the window. In both implementations (FIGS. 3 and 4, and FIG. 4A), the web page content display and the browsing history tree display are in two separate areas. In another alternative implementation (not shown), the browsing history tree and the web content are displayed in the same window area, where the browsing history tree display will temporarily displace the web content display (this implementation is not preferred but is possible).

In this tree representation of the browsing history, each node represents a web page that has been navigated to by the user; a line between two nodes represents the direction of navigation, i.e. navigating from one web page to the other. The lines between nodes may have arrows to indicate the direction. Alternatively, if the nodes are spatially arranged in a left-to-right manner or top-to-bottom manner, the lines can be displayed without arrows and the direction of navigation is assumed to be from left to right (even though the lines can be slanted up or down) or from top to bottom (even though the lines can be slanted left of right).

The nodes can be represented in a number of ways, using text or graphics. In one example, each node is represented by a name for the web page or a truncated version of the name. The name may be an URL or a name provided by the web page itself (like the title text of a tab). In another example, each node is represented by a thumbnail image of the page (i.e., a small, low resolution version of the image). The thumbnail is generated from the downloaded content of the page. Another example is to display only the tab icon of a give page. A combination of them—thumbnail image, URL, tab title text, tab icon—may also be used.

In the browsing history display window 31, each node is a selectable item; selecting the node will cause the browser to navigate to the web page corresponding to the node. Selecting may be done by clicking the node with a mouse, or touching the node if a touch sensitive screen is used. This constitutes a “go to” command similar to the “go to” commands in conventional browser programs.

A “go to” icon 42 may be provided in the browser window 41; when this icon is selected, the browsing history display window 31 is displayed or made active (e.g. brought to the front of the desktop).

“Back” and “forward” commands may be implemented in the browsing history display window 31 and/or the web browser window 41, which allow the user to traverse back or forward to the immediately previous or subsequent web page on the history tree. The “back” and “forward” commands may be implemented as back arrow (left-pointing) and forward arrow (right-pointing) icons, examples of which are shown in the browser window 41 in FIG. 4. Alternatively or in addition, the “back”, “forward” and “go to” commands may be implemented by a drop down menu, pop-up menu, keyboard key presses, etc.

In the case of a “forward” command, its meaning may be ambiguous if the current node is one that has two or more subsequent nodes extending from it. In such a case, the “forward” command may be implemented to go to the first (earliest in time) one of the subsequent nodes, or the last (latest in time) one of the subsequent nodes, or the command may be treated as invalid (i.e. the browser program will not respond to it).

Optionally, the “back” and “forward” commands may be implemented with a looped feature. In other words, when the current node is a leaf node, a “forward” command will bring the browser to the root node of the tree, or (alternatively) to the nearest branching node of the current node. When the current node is the root node, a “backward” command will bring the browser to one of the leaf nodes (e.g. the last one in time), or (alternatively) to the nearest branching node of the root node.

The browser window 41 can have any other desired features such as panes, icons, buttons, menus, text input fields, etc. to allow the user to perform various functions, and at least one pane to display the content of the web page.

FIG. 4A schematically illustrates a browser window according to an alternative implementation of the first embodiment. This browser window integrates a web page display area 41A for displaying web page content and a browsing history display area 44A for displaying the browsing history tree. The browsing history display area 44A is provided with back and forward buttons 43A, as well as a “close” button 45A which the use can use to close the browsing history display area 44A. When the area browsing history display 44A is closed, the web page display area 41A expands to fill the space made available.

The browsing history tree is constructed by storing the web pages that are navigated to in a browsing session. When the user navigates to a web page by a means other than a browsing history command, e.g., when the user enters a URL, or selects a link in the current page, etc., the new page is added to the browsing history tree as a new node subsequent to the current node. When the user uses a browsing history commands (e.g., “go to”, “back” or “forward” command) to navigate to a web page on the history tree, a new node is not added to the history tree.

It should be noted that the nodes in the browsing history tree are not required to be unique pages, i.e., they are not required to be different from one another. For example, suppose the user navigates from page L to page M by typing the URL of page A into the browser; a new node M will be added to the browsing history tree, even thought page M will be the same as page A in terms of content.

Even thought all nodes of the browsing history tree, including duplicative ones, are stored as a part of the history, it is possible to display the browsing history tree in a manner that temporarily hides the duplicative ones from the visual display, based on a display mode set by the user. For example, among duplicative nodes, the one that is first in time, or (alternatively) the last in time, may be displayed and all others hidden. As another alternative, preference is given branching nodes so that branching nodes are never hidden and duplicative nodes that are not branching nodes will be hidden. Also, the display may be designed so that if a “back” or “forward” command goes to a temporarily hidden node, it will be displayed.

Any suitable data structure may be used by the computer to store the browsing history tree. For example, the data structure may have a plurality of entries each corresponding to a node of the history tree, where each entry includes: an index of the entry, a location description (e.g. the URL of the web page), a first reference (e.g., a pointer, an index value, etc.) to an entry corresponding to the immediately previous node, and one or more second references to entries corresponding to the immediately subsequent nodes. Some entries may have no first reference or no second reference. When there are more than one second reference, they are preferably stored in the order in which they occurred during the browsing session, so that the browser program can implement the “forward” command in the manners described earlier. Other suitable data structures may be used.

FIG. 5 schematically illustrates a process executed by a web browser program that implements the first embodiment. While the web browser program is displaying a current web page (X) in a browser window (step S501), e.g. window 41 shown in FIG. 4, it concurrently displays a browsing history tree (step S502), preferably in a separate window from the web page display, e.g. the browsing history display window 31 shown in FIG. 3. The browsing history tree includes nodes corresponding to web pages that the user has visited in the browsing session so far. In the browsing history tree display, an indication is displayed to highlight the current node (X), i.e., the web page that is currently being displayed in the browser window 41. The indication may be a color highlight, a check mark, an arrow, etc. Steps S501 and S502 may represent any given point in the browsing session; in particular, they may represent the state of the browser at the start of a browsing session, where the page X is the start page and the browsing history tree displayed in step S502 has only one node X.

The browser program then receives a navigation command specifying a web page to be navigated to (step S503), which may be a navigation command of a first type or a navigation command of a second type. A navigation command of the first type is a command other than a browsing history command (“back”, “forward”, or “go to” command). For example, the navigation command of the first type may be in the form of a URL entered into the browser, a selection of a link in the currently displayed web page X, a search request entered into the web page X (for example, page X may be a search engine), etc. A navigation command of a second type is a browsing history command which specifies a node of the existing browsing history tree (e.g. “back”, “forward”, or “go to” command). As explained earlier, such command may be generated using an icon in the browser window 41 (FIG. 4) or the browsing history display window 31, or by selecting a node in the browsing history tree displayed in the browsing history display window 31. The browser program determines whether the navigation command received in step S503 is of the first type or second type (step S504).

In response to a navigation command of the first type (left branch of S504), the browser program navigates to the new web page (Y) specified in that command and displays the web page (Y) in the browser window (step S505). The browser program stores the new web page (Y) in the browsing history tree as a node immediately subsequent to the previous node (X), and updates the browsing history tree display in the browsing history display window 31 to include the new node (Y) (step S506). The indication in the browsing history tree display now highlights the node (Y) currently displayed in the browser window.

In response to a navigation command of the second type (right branch of S504), the browser program navigates to the web page (Z) specified in the navigation command of the second type and displays the page in the browser window (step S507). The web page (Z) is an existing page in the browsing history tree. A cached page may be used for displaying the page. The browser program updates the browsing history tree display by changing the highlight indication to highlight the existing node for the web page (Z), without adding the web page (Z) to the browsing history tree as a new node (step S508). Steps S503 to S508 may be repeated depending on the user's action.

In the browsing history display window 31 (see FIG. 3), all nodes of the browsing history tree are displayed (even though some may be minimized or located outside of the visible area of the window, as explained in more detail later). As pointed out earlier, the shape of the displayed browsing history tree depends on how the user browsed the web. At least for some browsing sessions, the browsing history tree has two or more branches; in other words, at least one node has three or more nodes (including one immediately previous node two or more immediately subsequent nodes) connected to it.

Depending on the browsing session, it is possible that a browsing history tree may have too many nodes than can be accommodated in the visible area of the browsing history display window 31 if all of them are displayed as thumbnails. Several methods may be implemented to resolve this issue. First, vertical and/or horizontal scroll bars may be implemented to allow the user to move the browsing history tree around and see different parts of the tree if it does not fit in the visible area of the window (see FIG. 6A, showing horizontal scroll bar 61). In a variation of this implementation, a “hand” tool may be implemented for the purpose of moving the browsing history tree image around in the window. Additionally, a zoom tool can be provided to allow the user to zoom out or in to see more or less of the tree at once.

Second, different sized thumbnails and/or icons may be used to represent different nodes of the tree. For example, nodes that are located closer to a node of interest, which may be the node of the currently displayed web page, or any desired node specified by the user, may be shown as larger thumbnails that allow their content to be seen better; nodes that are located farther away from the node of interest may be shown as smaller thumbnails or mere rectangular shapes or even dots (see FIG. 6B). In the example shown in FIG. 6B, node I is the node of interest (the node located at the lower-right hand corner of the tree is the currently displayed node). In one particular implementation, a single click or single touch of a node will result in that node being made the node of interest, and that node and other nodes near it will be displayed in larger icons; while a double click or double touch of a node will operate as a “go to” command.

Third, a moveable magnifier (sometimes also called a loupe tool) may be implemented to enlarge some of the thumbnails dynamically (see FIG. 6C). In this implementation, all thumbnails are displayed with sufficiently small sizes to allow all nodes to be visible in the window, and some selected nodes are magnified.

Fourth (not shown in the drawings), branches of the browsing history tree may be made collapsible and expandable; an icon such as a “+” or “−” sign may be displayed inside or adjacent relevant nodes to allow the user to expand collapse branches.

Fifth (not shown in the drawings), the browsing history tree may be display as semi-transparent objects that overlap or partially overlap the web page content display.

Other suitable display methods may be implemented. Combination of these display methods may also be used. Many of the afore-mentioned tools are generally known and can be implemented by those skilled in the relevant art without undue experimentation.

Of course, regardless of whether all nodes of the tree are visibly displayed, all nodes are stored in the data structure.

Although the above embodiments are described in the context of a web browser for browsing the Internet, the multi-branched history tree described here can be implemented in other browsing or navigation activities, such as navigating a folder structure on a computer. Many conventional folder navigation programs of various operating systems have the ability to store navigation history, but the histories have only a single linear chain structure. The history tree with multiple branches describe in embodiments of the present invention may be implemented for such navigation programs. In such an application, each node of the navigation history tree represents a folder that has been visited; the history tree is displayed in one display area similar to window 31 or area 44A shown in FIGS. 3 and 4A, and the contend of the current folder is displayed in another area similar to the areas 41 and 41A in FIGS. 4 and 4A.

In this disclosure, the terms “browsing” and “navigating” are used synonymously, and both mean moving from one location to another in a collection of data. The collection of data may be the World Wide Web in the web browsing application, and a folder structure on a computer in the folder navigation application. The locations in the collection of data may be web pages in the web browsing application, and folders in the folder navigation application.

A second embodiment of the present invention is described below in the context of a browsing session involving a web search. FIG. 7 schematically illustrates a browsing history display window 71 according to the second embodiment. Similar to the first embodiment, the browser program according to the second embodiment stores and displays a browsing history tree that can include multiple branches (see FIG. 7). In addition, when the user conducts a web search using a search engine, and a search result page is returned, the browser program automatically generates thumbnails for the plurality of links (search hits) in the search result page, and adds them to the browsing history tree display (even though the user has not visited these search hits yet).

Referring to the example shown in FIG. 7, page A is the home page of a search engine. The user types the search query into this page and requests a search. The browser returns a search result page, page B in FIG. 7, which is displayed in the browser window 41 and also added to the browsing history tree. This search result page typically contains a plurality of links that meet the search query, sometimes referred to as “search hits”. At this time, the browser program automatically generates thumbnails for the plurality of links contained in the search result page (B), and displays them in the browsing history display window as pages C1 to C5 shown in FIG. 7. To do this, the browser program automatically, i.e., without any user initiation, accesses each of the search hit links of the search result page, downloads the web page content of the links but without displaying the pages in the browser window 41, and generates the thumbnails based on the downloaded content. Thus, these thumbnails (referred to as the first level search hit thumbnails for convenience) correspond to the web pages that would be displayed if the user visits the corresponding links in the search result page.

As in the first embodiment, the user may select (click or touch) the thumbnails displayed in the browsing history display window 71 to navigate to the corresponding web page, including the first level search hit pages C1 to C5. Of course, the user can also navigate to a search hit page by clicking a link on the search result page B displayed in the browser window. In the example shown in FIG. 7, the user navigated to page C1 (one of the search hits), and navigated further from page C1 to pages D, E, F, G. The user also navigated to page C4 (another one of the search hits), and navigated further from page C4 to pages H, I. The User navigated to page C3, and further to page J which is the currently displayed page in the browser window. The nodes D through J are added to the browsing history tree and displayed in the browsing history display window as the user visits the pages, in a manner similar to the first embodiment. In the example shown in FIG. 7, the user may or may not have visited pages C 2 and C5; as pointed out earlier, the first level search hit thumbnails are generated automatically even if the user has not visited the pages.

The back, forward and go to commands may be implemented for the second embodiment in a manner similar to the first embodiment.

In a preferred embodiment, the automatic generation and display of first level search hit thumbnails is only implemented for a web page that represents a search result (referred to as a search result page for convenience), not for all web pages visited during a browsing session. This is because a user is far more likely to want to click on multiple links in a search result page than to click on multiple links of a general web page. Thus, for example, if the user navigates to page C1 in the example of FIG. 7, the browser program will display the content of that page, but will not automatically generate thumbnails for any link contained in that page.

To accomplish this, the browser program implements a mechanism to detect whether a web page is a search result page or not. One way to implement this mechanism is to detect whether the URL of the page (1) indicates a search engine and (2) contains a query string as defined in the Hypertext Transfer Protocol (HTTP). In one example, if the domain name contained in the URL is that of one of the commonly used search engines such as Google™ Bing™, Yahoo™, etc., it may be deemed to indicate a search engine. In another example, if the URL (in the domain name part or elsewhere) contains the word “search”, the URL may also be deemed to indicate a search engine. Alternatively or in addition, the browser program may allow the user to designate what domain names will be deemed to indicate a search engine, or to designate specific text strings in URLs that will be deemed to indicate a search engine. The browser program will then detect such domain names or text strings in the URL. Optionally, the browser program may allow the user to limit the automatic thumbnail generation function to only a specific list of domain names that have been affirmatively designated by the user; this will reduce unwanted automatic thumbnail generation.

For clarity, the term “qualified search result page” is used in this disclosure. Qualified search result pages are a special type of pages that satisfy certain criteria defined by the browser, such as those described in the preceding paragraph. The criteria are designed (and can be customized by the user) such that qualified search result page will include most of the search result pages generated by popular or the user's favorite web search engines, but will not be overly inclusive. The automatic thumbnail generation function is only implemented for qualified search result pages.

Another issue is the presence of links on some search result pages that are not search hits. These may include advertisement, links for general topics (typically located at the top or bottom of the page), etc. Preferably, the non-search-hit links are not automatically accessed and their thumbnails are not automatically generated or displayed in the browsing history tree. For this purpose, a mechanism is implemented to distinguish search hits from other links on a search result page. Some search engines designate ad data in the html data of the search result, but do not normally allow a user to hide or disable the ads when the search result is displayed. The browser can be implanted to still display the ads in the browser window, thereby fulfilling the advertising function, but to filter out the ad links when automatically generating thumbnails for the browsing history tree display. More generally, any suitable method of filtering out ad links may be used here.

FIG. 8 schematically illustrates a process executed by a web browser program that implements the second embodiment. Step S801 and S802 are similar to step S501 and S502 of the first embodiment shown in FIG. 5, and represents a current state of the browser program. The browser program then receives a navigation command specifying a web page to be navigated to (step S803), which may be a navigation command of a first type, a second type or a third type. A navigation command of a second type is defined in the same way as in the first embodiment (FIG. 5), i.e., it is a browsing history command which navigates to a node of the existing browsing history tree (e.g. “back”, “forward”, or “go to” command).

A navigation command of the third type is a command that will return a qualified search result page. For convenience, it is also referred to as a qualified search command in this disclosure. As described above, qualified search result pages satisfy certain criteria defined by the browser; thus, the navigation command of the third type can be differentiated from other types navigation commands using these criteria. Using the example given above, a navigation command can be deemed to be of a third type when the URL (1) indicates a search engine and (2) contains a query string as defined in the Hypertext Transfer Protocol (HTTP).

A navigation command of the first type is a command that is not of the second type (browsing history command) and not of the third type (qualified search command). For example, the navigation command of the first type may be in the form of a clean URL entered into the browser, a selection of a link in the currently displayed web page X, etc.

In step S804, the browser program determines whether the navigation command received in step S803 is of the first, second or third type. If the navigation command is of the first type, the browser program performs a first process (step S805) which is identical to steps S505 and S506 of the first embodiment shown in FIG. 5 and described earlier. If the navigation command is of the second type (a browsing history command), the browser program performs a second process (step S806) which is identical to steps S507 and S508 of the first embodiment shown in FIG. 5 and described earlier.

If the navigation command is of the third type (a qualified search command), the browser program displays the search result page (U) returned by the command in the browser window (step S807). This search result page typically contains multiple search hits (links) Vᵢ. The browser program stores the search result page U in the browsing history tree as a new node subsequent to the previous node X (step S808). Then, the browser program accesses each of the multiple web pages Vᵢ corresponding to the search hits to download its web page content, and generates a thumbnail for each of the search hits using the downloaded content (step S809). The browser program stores the web pages Vᵢ of the search hits in the browsing history tree as new nodes subsequent to the search result page U (step S810). The browser program then updates the browsing history tree display to include newly added nodes U and Vᵢ (step S811).

It should be noted that although the browser program automatically downloads the web page content of the search hits Vᵢ for purpose of generating thumbnails, it does not display these pages in the browser window. Rather, the browser window displays the search result page itself, which typically lists the multiple search hits as links. Thus, at this time, the browser window displays the search result page U, while the browsing history tree display includes both the node U (search result page) and the nodes V, (the search hits). The nodes are displayed as thumbnails.

Steps S803 to S811 are repeated to process additional navigation commands from the user.

The browser program according to the second embodiment of the present invention is helpful for working with web searches.

It will be apparent to those skilled in the art that various modification and variations can be made in the improved web browser and related web navigation method of the present invention without departing from the spirit or scope of the invention. Thus, it is intended that the present invention cover modifications and variations that come within the scope of the appended claims and their equivalents.

What is claimed is:

1. A method implemented in a computer for navigating the World Wide Web (web), comprising:
displaying a web page in a first display area; and
displaying a browsing history tree in a second display area, wherein the browsing history tree includes a plurality of nodes each corresponding to a web page that has been navigated to during a browsing session, and a plurality of lines each connecting two of the plurality of nodes to indicate a direction of navigation, wherein at least one of the plurality of nodes has three or more nodes connected to it.

2. The method of claim 1, wherein one of the plurality of nodes is a current node which corresponds to the web page being displayed in the first display area, and wherein the method further includes highlighting the current node in the display of the browsing history tree.

3. The method of claim 2, further comprising:
receiving a navigation command which identifies a web page;
in response to receiving the navigation command:
displaying the identified web page in the first display area; and
updating the displayed browsing history tree to add a new node, which corresponds to the identified web page, as an immediately subsequent node of the current node, without eliminating any other nodes in the browsing history tree as previously displayed, and to highlight the new node.

4. The method of claim 2, further comprising:
receiving a back command which indicates a backward navigation direction, or a forward command which indicates a forward navigation direction, or a go to command which selects one of the plurality of nodes in the browsing history tree;
in response to receiving the back command, displaying a web page corresponding to an immediately previous node of the current node in the first display area, and updating the displayed browsing history tree to highlight the immediately previous node;
in response to receiving the forward command, displaying a web page corresponding to an immediately subsequent node of the current node in the first display area, and updating the displayed browsing history tree to highlight the immediately subsequent node; and
in response to receiving the go to command, displaying a web page corresponding to the selected node, and updating the displayed browsing history tree to highlight the selected node.

5. The method of claim 1, wherein the first display are and the second display area are two separate display windows.

6. The method of claim 1, wherein the first display are and the second display area are two separate areas of a common display window.

7. The method of claim 1, wherein in the displayed browsing history tree, at least some nodes are each represented by a thumbnail generated from content data of the corresponding web page.

8. The method of claim 7, wherein some other nodes are each represented by an icon smaller than the thumbnails.

9. A method implemented in a computer for navigating a collection of data, the collection of data comprising a plurality of data locations each having data content, the method comprising:
displaying content of a data location in a first display area; and
displaying a navigation history tree in a second display area, wherein the navigation history tree includes a plurality of nodes each corresponding to a data location that has been navigated to during a navigation session, and a plurality of lines each connecting two of the plurality of nodes to indicate a direction of navigation, wherein at least one of the plurality of nodes has three or more nodes connected to it.

10. The method of claim 8, wherein one of the plurality of nodes is a current node which corresponds to the data location for which the content is being displayed in the first display area, and wherein the method further includes highlighting the current node in the display of the navigation history tree.

11. The method of claim 10, further comprising:
receiving a navigation command which identifies a data location;
in response to receiving the navigation command:
displaying content of the identified data location; and
updating the displayed navigation history tree to add a new node, which corresponds to the identified data location, as an immediately subsequent node of the current node, without eliminating any other nodes in the navigation history tree as previously displayed, and to highlight the new node.

12. The method of claim 10, further comprising:
receiving a back command which indicates a backward navigation direction, or a forward command which indicates a forward navigation direction, or a go to command which selects one of the plurality of nodes in the browsing history tree;
in response to receiving the back command, displaying content of a data location corresponding to an immediately previous node of the current node in the first display area, and updating the displayed browsing history tree to highlight the immediately previous node;
in response to receiving the forward command, displaying content of a data location corresponding to an immediately subsequent node of the current node in the first display area, and updating the displayed browsing history tree to highlight the immediately subsequent node; and
in response to receiving the go to command, displaying content of a data location corresponding to the selected node, and updating the displayed browsing history tree to highlight the selected node.

13. A method implemented in a computer for browsing the World Wide Web (web), comprising:
(a) receiving first data representing content of a first web page;
(b) displaying the first web page in a first display area;
(c) determining whether the first web page includes a plurality of web links each corresponding to a web search hit;
(d) if the first web page is determined to include the plurality of web links each corresponding to a search hit, automatically obtaining second data representing contents for a plurality of second web pages respectively corresponding to the plurality of web links, and based on the second data, generating a plurality of thumbnail image respectively representing the plurality of second web pages;
(e) displaying a browsing history tree in a second display area, the browsing history tree including a plurality of nodes and a plurality of lines each connecting two of the plurality of nodes,
wherein the plurality of nodes includes a first node corresponding to the first web page and a plurality of second nodes respectively corresponding to the plurality of second web pages, and wherein the plurality of lines include a plurality of first lines each connecting the first node with one of the plurality of second nodes,
wherein the plurality of second nodes are respectively represented by the plurality of thumbnail images.

14. The method of claim 13, wherein one of the plurality of nodes is a current node which corresponds to the web page being displayed in the first display area, and wherein the method further includes highlighting the current node in the display of the browsing history tree.

15. The method of claim 14, further comprising:
receiving a navigation command which identifies a web page;
in response to receiving the navigation command:
displaying the identified web page in the first display area; and
updating the displayed browsing history tree to add a new node, which corresponds to the identified web page, as an immediately subsequent node of the current node, without eliminating any other nodes in the browsing history tree as previously displayed, and to highlight the new node.

16. The method of claim 14, further comprising:
receiving a back command which indicates a backward navigation direction, or a forward command which indicates a forward navigation direction, or a go to command which selects one of the plurality of nodes in the browsing history tree;
in response to receiving the back command, displaying a web page corresponding to an immediately previous node of the current node in the first display area, and updating the displayed browsing history tree to highlight the immediately previous node;
in response to receiving the forward command, displaying a web page corresponding to an immediately subsequent node of the current node in the first display area, and updating the displayed browsing history tree to highlight the immediately subsequent node; and
in response to receiving the go to command, displaying a web page corresponding to the selected node, and updating the displayed browsing history tree to highlight the selected node.

17. The method of claim 13, wherein step (c) includes determining whether a uniform resource identifier for the first web page indicates a search engine and contains a Hypertext Transfer Protocol (HTTP) query string.

18. The method of claim 17, wherein the uniform resource identifier for the first web page is determined to indicate a search engine if it contains a domain name that matches one of a predefined plurality of domain names or if it contains one of a predefined plurality of strings.
